(19) United States
(12) Patent Application Publication
(10) Pub. No.: US 2018/0224068 A1
(43) Pub. Date: Aug. 9, 2018

(54) FACILITY FOR DISTRIBUTING WORKING GAS

(71) Applicants: L'Air Liquide, Société Anonyme pour I'Etude et I'Exploitation des Procédés Georges Claude, Paris (FR); Air Liquide Eletronics Systems, Paris (FR)

(72) Inventors: Aziz OUERD, Grenoble (FR); Hervé DULPHY, Jarrie (FR); Valère LAURENT, Villard Bonnot (FR); Stéphane SIAUVE, Sassenage (FR)

(21) Appl. No.: 15/749,173

(22) PCT Filed: Jul. 20, 2016
(86) PCT No.: PCT/FR2016/051876

§ 371 Date: Jan. 31, 2018

(30) Foreign Application Priority Data
Jul. 31, 2015 (FR) 1557392

(51) Int. Cl. F17C 13/08

(52) U.S. Cl. CPC F17C 13/084; F17C 2270/0518; F17C 2201/032; F17C 2201/056; F17C 2205/0111; F17C 2205/0134; F17C 2205/0326; F17C 2205/0338; F17C 2205/0341; F17C 2221/016; F17C 2221/035; F17C 2223/0123; F17C 2223/036; F17C 2225/0123; F17C 2225/033; F17C 2225/035; F17C 2227/044; F17C 2227/045; F17C 2250/032; F17C 2250/034; F17C 2250/043; F17C 2260/044; F17C 2270/05; F17C 2201/0104

(57) ABSTRACT

An installation for supplying gas provided with an insulating chamber including a rear wall and two side wall as well as a door that pivots about a vertical axis in order to allow opening and closing of the chamber, the installation including two multifunctional blocks that house a fluid circuit and are attached to the rear wall inside the chamber.

### CROSS REFERENCE TO RELATED APPLICATIONS

This application is a 371 of International Application PCT/FR2016/051876, filed Jul. 20, 2016, which claims priority to French Patent Application 1557392, filed Jul. 31, 2015, the entire contents of which are incorporated herein by reference.

### BACKGROUND

The invention relates to a device for distributing a working gas and to an installation for supplying such gases used to feed gases employed in the processes of various industries such as the semiconductor, photovoltaic, LED, flat screen industries or any other industries such as the mining and pharmaceutical industries from the cylinder to the equipment or reactor used for those processes.

The execution of these processes often necessitates the use of dangerous gases of high quality calling for example for automatic purging and continuous distribution. For example, the manufacture of electronic circuits necessitates the use of various gases termed “working” gases such as for example Cl₂, NH₃, HCl, HBr, NF₃ and WF₆, etc. that are mostly considered dangerous to man because of their toxicity and/or their flammability.

Many industrial installations require equipment able to control automatically the supply of gases and fluids to some of the equipment. In particular, the manufacture of integrated circuits generally includes a plurality of processes such as for example vapor phase deposition in which a gas is fed into a reaction chamber containing a semiconductor substrate. The temperature and the pressure for depositing various layers of materials developed to create the three-dimensional designs of integrated circuits are carefully controlled in this chamber.

All the substances transported into and out of the reaction chamber must be continuously monitored since the proportions of the various reagents that constitute the vapor atmosphere finally determine the physical dimensions of the elements that collectively constitute a single vast electric circuit on a miniscule silicon chip, notably transistors, capacitors and resistors.

One of the largest causes of integrated circuits malfunctioning can be attributed to microscopic dust particles that contaminate the working area in which the circuit is manufactured. A miniscule foreign body can damage a very costly circuit and render it unusable. In order to protect against this type of particle contamination semiconductor manufacturers manufacture their products in a protected “white room” environment.

The air admitted into a white room is filtered first, thus almost entirely eliminating undesirable gas particles. The technicians who work in these environments wear special masks and suits that prevent the introduction of substances that could damage their meticulous work. The costs linked to the maintenance and the correct operation of this highly specialized environment are considerable. Consequently, all the space of a white room must be used as efficiently as possible.

Over and above this critical requirement, the chemical products used must be distributed with great care. The liquid chemical products and the special gases used in the semiconductor industry are often toxic. The devices chosen for distributing these potentially dangerous products must ensure reliable use with protection from corrosion and leaks.

Standard “gas cabinets” are routinely and reliably usable above all for long-term production and distribution applications. These systems are entirely installed in large cabinets in dedicated rooms that can be tens of meters from the equipment to which they are connected.

The development of a safe gas distribution installation with its layout optimized, usable with any gas cylinder, with intelligent automated control, in processes of various industries such as the semiconductor, photovoltaic, LED, flat screen industries or any other industry such as the mining and pharmaceutical industries from the cylinder to the equipment or reactor used for those processes would constitute a major technological advance. The use of a device so innovative would meet a long felt want in such industries.

An object of the present invention is to alleviate some or all of the disadvantages of the prior art referred to above.

### SUMMARY

To this end the present invention consists in an installation for supplying gas provided with an insulative chamber including a rear wall and two side walls as well as a door that pivots about a vertical axis in order to allow opening and closing of the chamber, said installation including two multifunctional blocks that house a fluid circuit, are attached to said rear wall inside said chamber and each include:
a single high-pressure regulator,
a purging system made up of three low-pressure valves,
means for fluid connection to the contents of a cylinder,
an outlet allowing equipment to be supplied with gas,
   characterized in that the high-pressure regulator is located upstream of the purging system and in that the area occupied by each multifunctional block on said rear wall is less than 270 cm², preferably less than 220 cm².

By special gases is meant all gases generally used in the semiconductor industry. These can be inert, toxic, corrosive or pyrophoric gases. These special gases can be selected from: HF, WF₆, BCl₃, ClF₃, DCS, ₃MS, C₄F₆, C₄F₈O, C₄F₈, Butane, SO₂, Cl₂, C₃F₈, NH₃, Propane, SF₆, HBr, C₂F₆, CH₃F, HCl, CHF₃, N₂O contained in a cylinder B in liquefied form or from F₂, PH₃, B₂H₆, NO, NF₃, SiH₄, CF₄, CH₄, CO contained in the cylinder B in compressed form. Depending on the nature of the gas to be distributed and its state, either liquefied or compressed, the pressure inside the cylinders B and B′ is therefore between 0 bar and 200 bar inclusive.

Moreover, embodiments of the invention can include one or more of the following features:
Installation as defined above characterized in that two gas cylinders are contained in the chamber, each of the two cylinders being connected to one of the two multifunction blocks.
Installation as defined above further comprising a vacuum generator.
Installation as defined above characterized in that the purging system is a cruciform purging system comprising a first or pressurization pipe, a second or outlet pipe enabling the vacuum to be established and a third or extraction pipe enabling routing of the gas to be distributed to an equipment, the three pipes being connected at a point A located downstream of the pressure regulator.
Installation as defined above characterized in that the multifunction blocks further include a pressure sensor upstream of the pressure regulator.
Installation as defined above characterized in that the multifunction blocks further include a pressure sensor downstream of the pressure regulator.
Installation as defined above characterized in that the pressure sensor is upstream of the purging system.
Installation as defined above characterized in that it comprises a connector on one of its external walls that can be connected to an extraction system.
Installation as defined above characterized in that it includes a control system enabling actuation of the pneumatic valves and control of the pressure sensors and the purging cycles.
Installation as defined above characterized in that the control system includes a communication port selected from a wireless transmitter-receiver, an Ethernet port, a cellular radio transmitter-receiver, a WIFI transmitter-receiver and a Bluetooth transmitter-receiver.

According to one particular aspect of the invention, the outlet pressure of the pressure regulator is less than 10 bar.

In particular, when P₁ is less than 8 bars and when the supplied equipment allows it, the multifunction block does not include a high-pressure pressure regulator.

A filter can optionally be integrated upstream and/or downstream of the pressure regulator. This enabling protection of the pressure regulator and assuring the purity of the distributed gas, where appropriate. This is another advantage over the use of a standard “gas cabinet”.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a simplified block diagram of a multifunction block employed in the installation according to the invention.

FIG. 2 is a simplified diagram of the installation according to the invention with its door closed.

### DESCRIPTION OF PREFERRED EMBODIMENTS

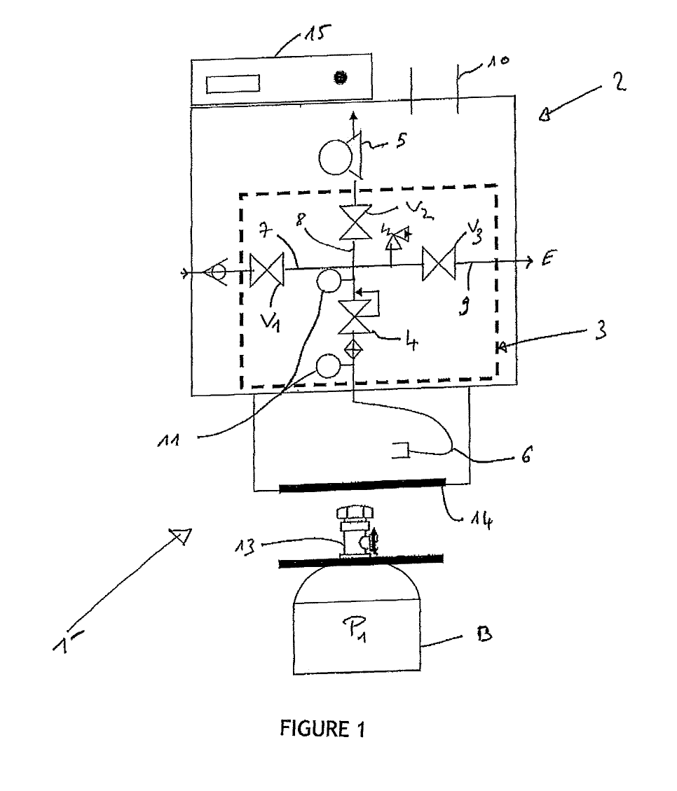

In FIG. 1 is shown a special gases distribution system 1′ consisting of a gas cylinder B and a special gases distribution device 2 adapted to be fixed to the cylinder B.

The device 2 includes a vacuum generator 5 and a multifunction block 3 comprising a single high-pressure pressure regulator 4, a purging system comprising three valves V₁, V₂ and V₃, and means 6 for connection to the content of the cylinder B.

The pressure regulator 4 is upstream of the purging system so that gas from the cylinder B at a pressure P₁ reaches the pressure regulator 4 at that pressure P₁. At the outlet of the pressure regulator 4 the gas flows at a pressure of the order of a few bar, i.e. at low pressure.

Consequently, the valves V₁, V₂ and V₃ and all other components liable to be included in the multifunction block 3 are in contact with a gas at low pressure. This is a considerable advantage in terms of reliability, safety and component service life. This also reduces the risk of leaks.

Additionally, this feature enables miniaturization of components such as membrane valve actuators, gas pipes and seals, for example, as well as simplification of their arrangement.

The purging system includes a first pipe 7 on which the valve V₁ is situated and intended to receive a purge gas G pressurizing the circuit when the valve V₁ is open. Said purge gas G can be chosen from nitrogen, argon and helium. Nitrogen is preferably used for purging. A second pipe 8 including the valve V₂ is intended to connect the first pipe 7 to the vacuum generator 5, which can be a miniature electric pump or a Venturi. The connection can also be left free to enable connection to an external vacuum system.

These first and second pipes 7 and 8 are connected at a point A downstream of the pressure regulator 4 to a pipe 9 including the valve V₃ and intended to supply the equipment E when the value V₃ is open.

Conventional purging systems generally further include a valve termed the isolating valve upstream of the pressure regulator.

This isolating valve is in theory necessary in the event of leaks or alarms resulting from a possible accident hazard following a malfunction of the system. Indeed, the function of this valve is to shut down the distribution system in such a situation. That is not necessary here because the volume of the block 3 is so small that the risk of leaks between the cylinder B and the pressure regulator 4 is considerably lower.

Also, this valve is of no utility because the applications of the system according to the invention are of very limited duration given what is implied by the permanent presence of an operator alongside the device who is able to stop the application in the event of an alarm. In the case of a cylinder including a pneumatic valve, the latter can also be controlled by the device according to the invention. The device according to the invention therefore does not contain any element sensitive to contact with a gas at high pressure.

The distribution device 2 according to the present invention can also include a vent 10 enabling extraction of the gas in the event of a leak. Indeed, the special gases used in the semiconductor industry are hazardous. It is for this reason that the standard special gas distribution devices are enclosed in an installation 1 in the form of a gas cabinet. Here the miniaturization of the device enables enclosure of the small number of components disposed in a simplified manner in a multifunction block 3 of small volume providing the necessary protection.

The distribution device 2 can also include in its multifunction block 3 pressure sensors 11 disposed for example upstream and/or downstream of the pressure regulator.

The distribution device 2 is controlled via a system 15 enabling control of the pneumatic valves V₁, V₂ and V₃ and automation of the purging sequence.

This system 15 includes for example an electrical power supply, solenoid valves for actuating the pneumatic valves, a logic controller, an emergency stop button, and a screen, for example an LCD screen, for displaying the status of the system.

The control system consists for example of a programmable logic controller.

This control system 15 includes for example a communication port chosen from a wireless transmitter-receiver, an Ethernet port, a cellular radio transmitter-receiver, a WIFI transmitter-receiver and a Bluetooth transmitter-receiver.

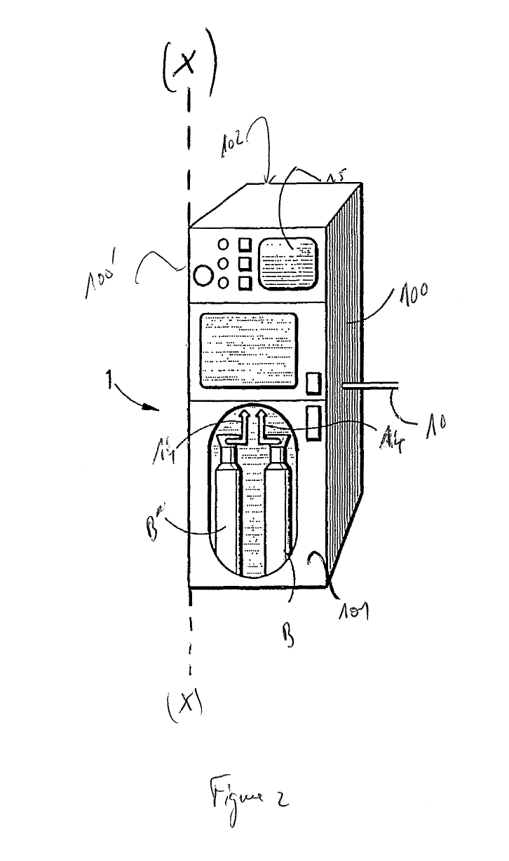

An installation 1 according to the invention is shown in FIG. 2. The installation 1 includes an enclosure with two lateral walls 100′, a door 101 that can pivot about an axis (X) in order to open and close the enclosure, and a rear wall 102. There are two gas cylinders B and B′ inside the enclosure and each is connected to a multifunction block 3 as shown in FIG. 1 via connection means 6. The installation 1 as shown in FIG. 2 has its door 101 closed and contains inside its enclosure two multifunction blocks 3 as shown in FIG. 1.

The small volume because of the multifunction blocks 3 employed for the distribution of the gas in an installation according to the invention guarantees safe and rapid manipulation of toxic, corrosive, flammable and pyrophoric gases.

The present invention enables reduction of the number of particle traps in the multifunction blocks 3. The invention employs a device featuring fast and easy installation, troubleshooting and modification means. It is indeed simple to transport and to manipulate these blocks 3.

The invention described has a simplified structure suited to the intended applications, which makes it possible to minimize the cost and the overall size of the product. The main component of the installation according to the present invention, i.e. the block 3 incorporating the pressure regulator 4 and the three valves V₁, V₂ and V₃ developed specifically for this application, is a novel feature enabling a significant saving in space and reduction in overall size.

The structure has been specifically designed in order to minimize the cost, the overall size and the number of components whilst retaining the necessary functionalities.

In order to enable uninterrupted distribution of gas the two blocks 3 each fixed to one gas cylinder (B and B′) are integrated into the installation 1 according to the invention (they are for example disposed side by side on the rear wall of the enclosure of the installation) to enable switching from the first cylinder to the second when it has reached its lowest filling level (switching threshold).

This equipment therefore benefits from the use of the blocks 3 (high-pressure pressure regulator upstream of the low-pressure valves, reduced purge volume, low cost) and of the switching device developed in installations termed “gas cabinets”.

The continuity of distribution of gas is a requirement of users of this kind of equipment that enables them to prevent interruption of production. Installations according to the present invention differ from the systems known until now, for example miniature installations, in that they can be mounted on a cylinder, offering a very small footprint as they take up hardly more space than the cylinder itself, which suits users of small quantities of gas in a discontinuous manner, such as laboratories, which can sometimes have constraints in terms of space.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-10. (canceled)

11. An installation for supplying gas provided with an insulating chamber including a rear wall and two side wall as well as a door that pivots about a vertical axis in order to allow opening and closing of the chamber, said installation including two multifunctional blocks that house a fluid circuit, are attached to the rear wall inside the chamber and each include:
i. a single high-pressure regulator,
ii. a purging system made up of three low-pressure valves,
iii. a means for fluid connection to the contents of a cylinder,
iv. an outlet allowing equipment to be supplied with gas,
wherein the high-pressure regulator is located upstream of the purging system, and wherein the area occupied by each multifunctional block on the rear wall is less than 270 cm², and wherein the two blocks each fixed to a cylinder are adapted to allow automatic switching from one cylinder to the other in order to enable uninterrupted distribution of gas.

12. The installation as claimed in claim 11, wherein the two gas cylinders are contained in the chamber, each of the two cylinders being connected to one of the two multifunction blocks.

13. The installation as claimed in claim 11, further comprising a vacuum generator.

14. The installation as claimed in claim 11, wherein the purging system is a cruciform purging system comprising a first or pressurization pipe (7), a second or outlet pipe enabling the vacuum to be established and a third or extraction pipe enabling routing of the gas to be distributed to an equipment, the three pipes being connected at a point A located downstream of the pressure regulator.

15. The installation as claimed in claim 11, wherein the multifunction blocks further include a pressure sensor upstream of the pressure regulator.

16. The installation as claimed in claim 11, wherein the multifunction blocks further include a pressure sensor downstream of the pressure regulator.

17. The installation as claimed in claim 11, wherein the pressure sensor is upstream of the purging system.

18. The installation as claimed in claim 11, further comprising a connector on one of the external walls that can be connected to an extraction system.

19. The installation as claimed in claim 14, further comprising a control system enabling actuation of the pneumatic valves and control of the pressure sensors and the purging cycles.

20. The installation as claimed in claim 11, wherein the control system includes a communication port selected from a wireless transmitter-receiver, an Ethernet port, a cellular radio transmitter-receiver, a WIFI transmitter-receiver and a Bluetooth transmitter-receiver.
